(19) United States
(12) Patent Application Publication
(10) Pub. No.: US 2005/0038902 A1
(43) Pub. Date: Feb. 17, 2005

(54) Storing data packets

(76) Inventors: Raju Krishnamurthi, Kamataka (IN); Padmini Yadlapati, Kamataka (IN); Suryakant Maharana, Kamataka (IN)

Correspondence Address: FISH & RICHARDSON, PC, 12390 EL CAMINO REAL, SAN DIEGO, CA, 92130-2081, US

(21) Appl. No.: 10/642,129

(22) Filed: Aug. 14, 2003

(51) Int. Cl. G06F 15/16

(52) U.S. Cl. 709/232

(57) ABSTRACT

A method and system for processing data packets are described. The method stores a data packet in a memory location and locks the data packet memory location when the data packet is an IP multicast packet. The method can also set a count equal to a number of transmission ports of the data packet, decrement the memory count after each transmission of the data packet and make the memory location unlockable when the status count is equal to a predetermined value.

### BACKGROUND

Networks enable computers and other devices to exchange data such as e-mail messages, web pages, audio, video, and so forth. To send data across a network, a sending device typically constructs a collection of packets. A receiver reassembles the data into its original form after receiving the packets.

A packet traveling across a network may make many “hops” to intermediate network devices before reaching its final destination. A packet not only includes data being transported but also includes information used to deliver the packet. This information is often stored in the packet's “payload” and “header(s),” respectively. The header(s) may include information for a number of different communication protocols that define the information that should be stored in a packet. Different protocols may operate at different layers. For example, a low level layer generally known as the “link layer” coordinates transmission of data over physical connections. A higher level layer generally known as the “network layer” handles routing, switching, and other tasks that determine how to move a packet forward through a network.

Many different hardware and software schemes have been developed to handle packets. For example, some designs use software to program a general purpose Central Processing Unit (CPU) processor to process packets. Other designs use components known as application-specific integrated circuits (ASICs), feature dedicated, “hard-wired” approaches and still others use programmable devices known as network processors. Network processors enable software programmers to quickly reprogram network processor operations. Yet, due to their specially designed architectures, network processors can often rival the packet processing speed of an ASIC.

### DESCRIPTION OF DRAWINGS

FIG. 1 is a block diagram of a communication system employing a hardware-based multithreaded processor.

FIG. 2 is a block diagram of a micro engine unit employed in the hardware-based multithreaded processor of FIG. 1.

FIG. 3 is a block diagram depicting a collection of nodes.

FIG. 4 is a block diagram depicting nodes with an IP multicast node.

FIG. 5 is a flow chart depicting processing of a packet.

FIG. 6A is a flow chart for updating the lock and service count.

FIG. 6B is a flow chart for updating the lock and service count.

### DETAILED DESCRIPTION

A network processor receives a packet and stores the packet information in a memory location. The network processor determines the number of ports and number of replications for each port to transmit a received packet. During this period the packet is stored in memory and replications of the packet are produced. These replications are transmitted out of the transmit ports. Once the replications have been completed the stored packet information in memory is no longer necessary and new packets are stored in the old packet's memory location. During periods of high activity the memory of the network processor can become limited. A network processor that has a backlog of memory packets may start to write over memory locations of packets that have not completed the required replications. A lock is used to prevent the memory location from being used and erased prior to completion of the replications of the packet. The memory location is initially unlocked. When the packet is received and stored the process, the packet header is examined to determine if the location needs to be locked to prevent prematurely erasing packet information. A count can also be used to prevent packet memory locations from being prematurely erased prior to completion of the replications. When the packet is received the process determines the number of transmit ports for the first replication of the packet. The count is incremented by the number of transmit ports. The process decrements the count after each replication is transmitted out of a port. A replication is a copy of the packet with edit information to direct the packet's next hop. For each successive replication of the packet the count is incremented by the number of transmit ports for that respective replication. As replications are transmitted out of transmit ports the count is decremented. Eventually the replications are transmitted and the count is equal to zero. The memory location is then made available to store a new packet.

A network processor in general can comprise a bus connecting a processor, memory, and a media access controller device. Many network processors also include multiple instruction set processors. Intel's IXP processor® is an example of a network processor with multiple instruction set processors. Intel's IXP processor® is one example of a network processor. Other network processors can have different architectures and utilize the memory lock and count.

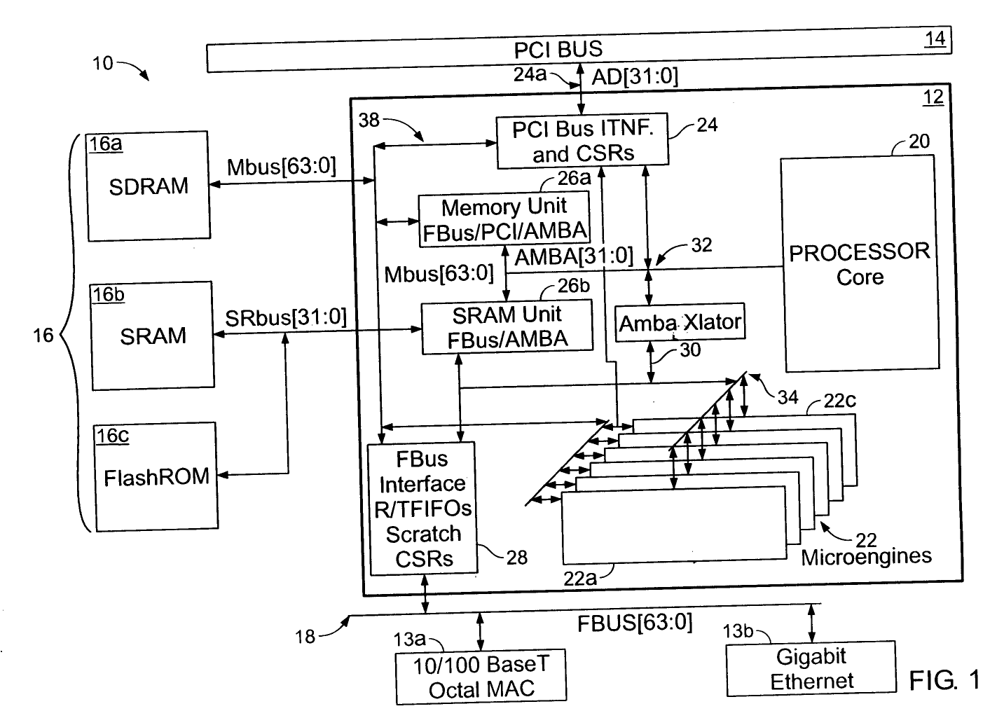

Referring to FIG. 1, a communication system 10 includes a parallel, hardware-based multithreaded processor 12. The hardware-based multithreaded processor 12 is coupled to a bus such as a Peripheral Component Interconnect (PCI) bus 14, a memory system 16 and a second bus 18. The system 10 is especially useful for tasks that can be broken into parallel subtasks. Specifically, the hardware-based multithreaded processor 12 is useful for tasks that are bandwidth oriented rather than latency oriented. The hardware-based multithreaded processor 12 has multiple microengines 22 each with multiple hardware controlled program threads that can be simultaneously active and independently work on a task. A program thread is an independent program that runs a series of instruction. From the program's point-of-view, a program thread is the information needed to serve one individual user or a particular service request.

The hardware-based multithreaded processor 12 also includes a central controller 20 that assists in loading microcode control for other resources of the hardware-based multithreaded processor 12 and performs other general purpose, computer-type tasks such as handling protocols, exceptions, and extra support for packet processing where the microengines pass the packets off for more detailed processing such as in boundary conditions. The processor 20 in this example is a Strong Arm® (Arm is a trademark of ARM Limited, United Kingdom) based architecture. The general purpose microprocessor 20 has an operating system. Through the operating system the processor 20 can call processes to operate on microengines 22a-22f. The processor 20 can use a supported operating system, preferably a real-time operating system.

The hardware-based multithreaded processor 12 also includes a plurality of microengines 22a-22f. Microengines 22a-22f each maintain a plurality of program counters in hardware and states associated with the program counters. Effectively, a corresponding plurality of sets of program threads can be simultaneously active on each of the microengines 22a-22f while only one is actually operating at one time.

In this example, there are six microengines 22a-22f, each having capabilities for processing at least four hardware program threads. The six microengines 22a-22f operate with shared resources including memory system 16 and bus interfaces 24 and 28. The memory system 16 includes a Synchronous Dynamic Random Access Memory (SDRAM) controller 26a and a Static Random Access Memory (SRAM) controller 26b. SDRAM memory 16a and SDRAM controller 26a are typically used for processing large volumes of data, e.g., processing of network payloads from network packets. The SRAM controller 26b and SRAM memory 16b are used in a networking implementation for low latency, fast access tasks, e.g., accessing look-up tables, memory for the core processor 20, and so forth.

Hardware context swapping enables other contexts with unique program counters to execute in the same microengine. Hardware context swapping also synchronizes completion of tasks. For example, two program threads could request the same shared resource, e.g., SRAM. When each of these separate units, e.g., the FBUS interface 28, the SRAM controller 26a, and the SDRAM controller 26b, complete a requested task from one of the microengine program thread contexts, they report back a flag signaling completion of an operation. When the flag is received by the microengine, the microengine can determine which program thread to turn on.

As a network processor, the hardware-based multithreaded processor 12 interfaces to network devices such as a media access controller device, e.g., a 10/100 BaseT Octal MAC 13a or a Gigabit Ethernet device 13b coupled to communication ports or other physical layer devices. In general, as a network processor, the hardware-based multithreaded processor 12 can interface to different types of communication devices or interfaces that receive/send large amounts of data. The network processor can include a router 10 in a networking application route network packets amongst devices 13a, 13b in a parallel manner. With the hardware-based multithreaded processor 12, each network packet can be independently processed 26.

The processor 12 includes a bus interface 28 that couples the processor to the second bus 18. The bus interface 28 in one embodiment couples the processor 12 to the so-called FBUS 18 (FIFO bus). The FBUS interface 28 is responsible for controlling and interfacing the processor 1b2 to the FBUS 18. The FBUS 18 is a 64-bit wide FIFO bus, used to interface to Media Access Controller (MAC) devices. The processor 12 includes a second interface, e.g., a PCI bus interface, 24 that couples other system components that reside on the PCI 14 bus to the processor 12. The units are coupled to one or more internal buses. The internal buses are dual buses (e.g., one bus for read and one for write). The hardware-based multithreaded processor 12 also is constructed such that the sum of the bandwidths of the internal buses in the processor 12 exceed the bandwidth of external buses coupled to the processor 12. The processor 12 includes an internal core processor bus 32, e.g., an Advanced System Bus (ASB bus) that couples the processor core 20 to the memory controllers 26a, 26b and to an ASB translator 30 described below. The ASB bus is a subset of the so-called AMBA bus that is used with the Strong Arm processor core. The processor 12 also includes a private bus 34 that couples the microengine units to SRAM controller 26b, ASB translator 30 and FBUS interface 28. A memory bus 38 couples the memory controller 26a, 26b to the bus interfaces 24 and 28 and memory system 16 including flashrom 16c used for boot operations and so forth.

Each of the microengines 22a-22f includes an arbiter that examines flags to determine the available program threads to be operated upon. The program thread of the microengines 22a-22f can access the SDRAM controller 26a, SDRAM controller 26b or FBUS interface 28. The SDRAM controller 26a and SDRAM controller 26b each include a plurality of queues to store outstanding memory reference requests. The queues either maintain order of memory references or arrange memory references to optimize memory bandwidth.

Although microengines 22 can use the register set to exchange data, a scratchpad or shared memory is also provided to permit microengines to write data out to the memory for other microengines to read. The scratchpad is coupled to the bus 34.

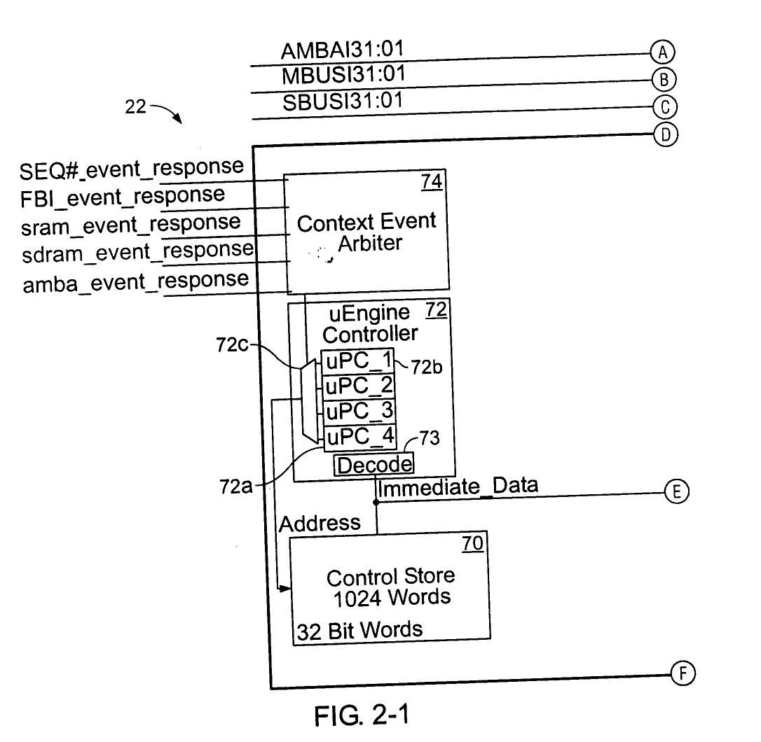

Referring to FIG. 2, an exemplary one of the microengines 22a-22f, e.g., microengine 22f is shown. The microengine includes a control store 70, which in one implementation, includes a RAM. The RAM stores a microprogram that is loadable by the core processor 20. The microengine 22f also includes controller logic 72. The controller logic includes an instruction decoder 73 and program counter (PC) units 72a-72d. The four micro program counters 72a-72d are maintained in hardware. The microengine 22f also includes context event switching logic 74. Context event logic 74 receives messages (e.g., SEQ_#_EVENT_RESPONSE; FBI_EVENT_RESPONSE; SRAM_EVENT_RESPONSE; SDRAM_EVENT_RESPONSE; and ASB _EVENT_RESPONSE) from each one of the shared resources, e.g., SRAM 26a, SDRAM 26b, or processor core 20, control and status registers, and so forth. These messages provide information on whether a requested task has completed.

In addition to event signals that are local to an executing program thread, the microengines 22 employ signaling states that are global. With signaling states, an executing program thread can broadcast a signal state to the microengines 22. The program thread in the microengines can branch on these signaling states. These signaling states can be used to determine availability of a resource or whether, a resource is due for servicing.

The context event logic 74 has arbitration for the program threads. In one embodiment, the arbitration is a round robin mechanism. Other techniques could be used including priority queuing or weighted fair queuing. The microengine 22f also includes an execution box (EBOX) data path 76 that includes an arithmetic logic unit 76a and general purpose register set 76b. The arithmetic logic unit 76a performs arithmetic and logic operations as well as shift operations. The registers set 76b has a relatively large number of general purpose registers. In this implementation there are 64 general purpose registers in a first bank, Bank A, and 64 in a second bank, Bank B. The general purpose registers are windowed so that they are relatively and absolutely addressable.

The microengine 22f also includes a write transfer register stack 78 and a read transfer stack 80. These registers are also windowed so that they are relatively and absolutely addressable. The write transfer register stack 78 is where write data to a resource is located. Similarly, the read register stack 80 is for return data from a shared resource. Subsequent to or concurrent with data arrival, an event signal from the respective shared resource, e.g., the SRAM controller 26a, SDRAM controller 26b or core processor, 20 will be provided to context event arbiter 74 which will then alert the program thread that the data is available or has been sent. Both transfer register banks 78 and 80 are connected to the execution box (EBOX) 76 through a data path. In one implementation, the read transfer register has 64 registers and the write transfer register has 64 registers.

Each microengine 22a-22f supports multi-threaded execution of multiple contexts. One reason for this is to allow one program thread to start executing just after another program thread issues a memory reference and must wait until that reference completes before doing more work. This behavior maintains efficient hardware execution of the microengines because memory latency is significant.

Network processors such as the example described above often handle a variety of protocols to transport data packets. One protocol is sending data packets from a single point, such as the sender, to a single point, such as the user; this is often referred to as unicast transmission.

A drawback of unicast transmission is that the packet travels on one path to the final destination. This increases the chances that a disruption in the path of the packet will result in the packet not reaching its final destination. In addition, the packet may take a path that is not the most direct to the final destination. Since a router at a node may not be aware of an overall quicker route the packet may be sent to a node that is further away from the packet's final destination. In addition, the router can only send one replication of the packet out of one port. Therefore, even though the router may have two possible routes, the router must select one to transmit the packet.

An alternative to unicast transmission allows data packets to be sent from a single point to multiple branch points to the final point. This method of sending information, called layer 2 multicast transmission, is a more efficient way of transmitting data packets in a network. The network has a number of multicast capable routers and the information enters the network as a single data packet from a source to a multicast router. As the data packet travels through the network, multicast capable routers replicate the data packet and send the information to downstream routers.

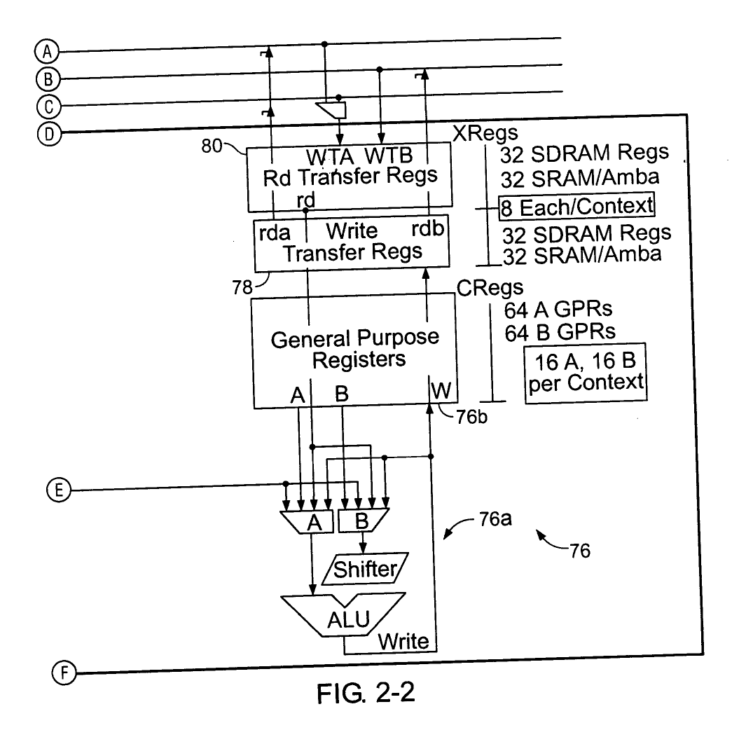

Referring to FIG. 3, the router at node 2 would receive a data packet from node 1 and then replicate the data packet and send data packets to nodes 3, 4, and 5. The router at node 3 would receive the data packet and replicates the data packet and sends data packets to nodes 4, 6, and 7. Thus, while only one data packet was transmitted from node 1, four data packets were received at the final destinations nodes 4, 5, 6, and 7. The multicast transmission allows the source to transmit one data packet, making efficient use of the source bandwidth while transmitting the data packet to four final destinations.

To perform layer 2 multicast, a server, router or switch first receives the data packet. The server then determines which locations downstream should receive the data packet. The server does this by processing the packet header to determine the packet's final destinations. The server then uses a routing table stored in the server's memory to determine the next possible upstream hops to advance the data packet to its final destination. The server sends the data packet to the next set of hops. This can involve multiple destinations requiring the server to make multiple replications of the data packet. For example, the server at node 2 in FIG. 3 would have to make three replications of the data packet. One replication would be sent to node 3, another replication would be sent to node 4, and a last replication would be sent to node 5. This involves a replication for each transmission.

A difficulty with layer 2 multicasting is that it produces excess traffic on the network. In the example shown in FIG. 3, the packet is sent to node 7 via nodes 3 and 4. While this produces only one extra packet in the simple example, on a large-scale network layer 2 multicasting produces a large excess of packets that congest the network and cause packet delays and forces packets to be dropped. IP multicasting is a networking technology that aims to deliver information to multiple destination nodes while minimizing the traffic carried across the intermediate networks. To achieve this, instead of delivering a different copy of each packet from a source to each end-station, packets are delivered to special IP multicast addresses that represent the group of destination stations and intermediate nodes take care of producing extra copies of the packets on outgoing ports as needed.

A characteristic that distinguishes IP Multicast packets from layer 2 packets (Ethernet for instance) is that on layer 2 multicasting only one copy of the packet needs to be delivered to each outgoing port per input packet, whereas for IP Multicasting multiple copies of a single packet may need to be delivered on a given outgoing port, e.g. a different copy needs to be sent on each virtual local area network (VLAN) where at least one member of the multicast group is present on that port. For example, if ten customers sign-up for a video broadcast program and each of them is in a different VLAN but the ten VLANS are all co-existing and reachable through the same output port, 10 distinct copies of the packet will be sent on that port.

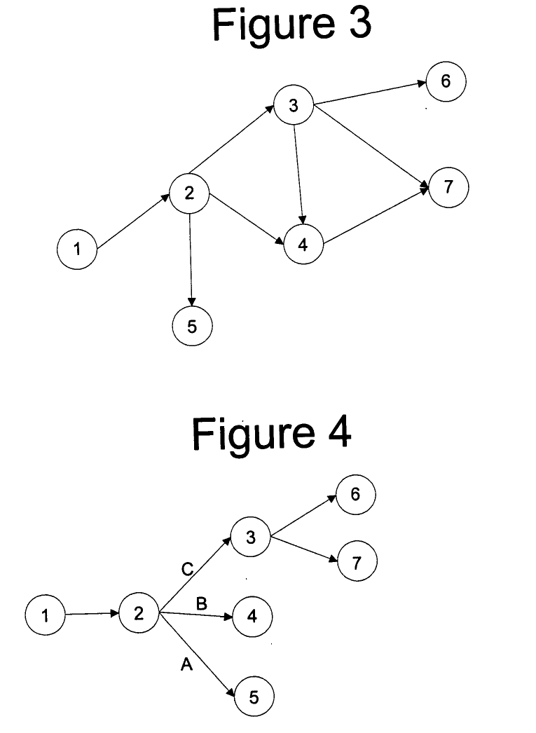

Referring now to FIG. 4, the original example has node 2 being an IP multicast server with an IP multicast address. The IP multicast server transmits one replication of the data packet out of port A to node 5 and one replication of the data packet out of port B to node 4. In addition, the IP multicast router also transmits two replications out of port C. One of these replications is destined for node 6 and the other replication is destined for node 7. While IP multicasting more efficiently distributes packets across the network, it also increases demands on servers at the intermediate nodes.

With unicast transmission, a server receives the data packet and stores the data packet in memory. The server processes the header of the data packet to determine the next destination to transmit the data packet. The server replicates the data packet and transmits it. Since the server only replicates and transmits the packet once, the server is now ready to handle the next data packet. The server receives the next data packet and stores it in the same memory as the previously transmitted data packet. The server processes and transmits the data packet.

However, this method of processing packets by a server can become inefficient when multicast packets require multiple replications. The time required to replicate a packet can often diverge from the time required to transmit the data packet. One way of dealing with this issue is to have multiple memory locations. This allows the server to continually receive data packets and process data packets while previous data packets are replicated and transmitted. However, without a sufficiently large memory there exists the potential that replication bottleneck will cause a memory location to be written over prior to completion of each replication.

IP multicasting compounds the inefficiency. Not only are replications made to send down multiple ports but also multiple replications may need to be sent out of each port. The time period to replicate the packet, delays due to transmitting to multiple ports, and delays due to transmitting multiple packets on the same port can produce a backlog of packets that have been received and stored but not are not finished replicating and transmitting. Even with sufficiently large memory there is still the possibility of writing over a packet in memory prior to completion of each replications and transmission.

To prevent the packet memory from being erased prematurely before each replications have been produced, a lock prohibits the packet memory location from being written over prior to completion of each replications and transmissions. The locked memory state can also be controlled by a service count.

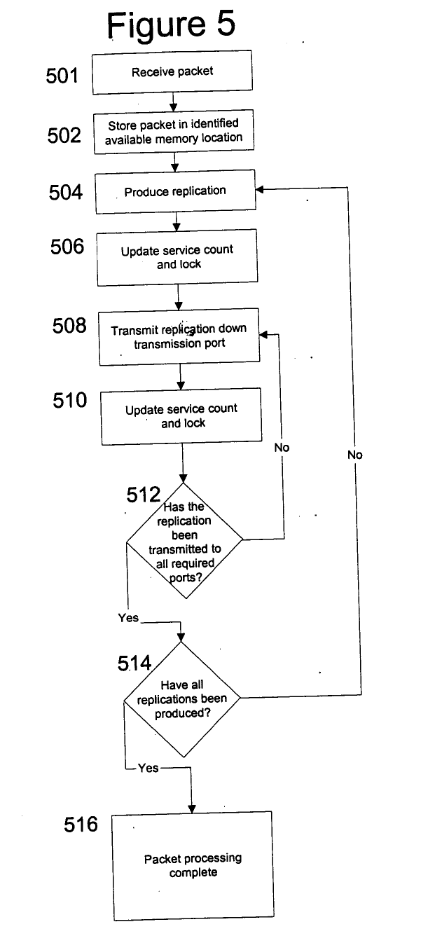

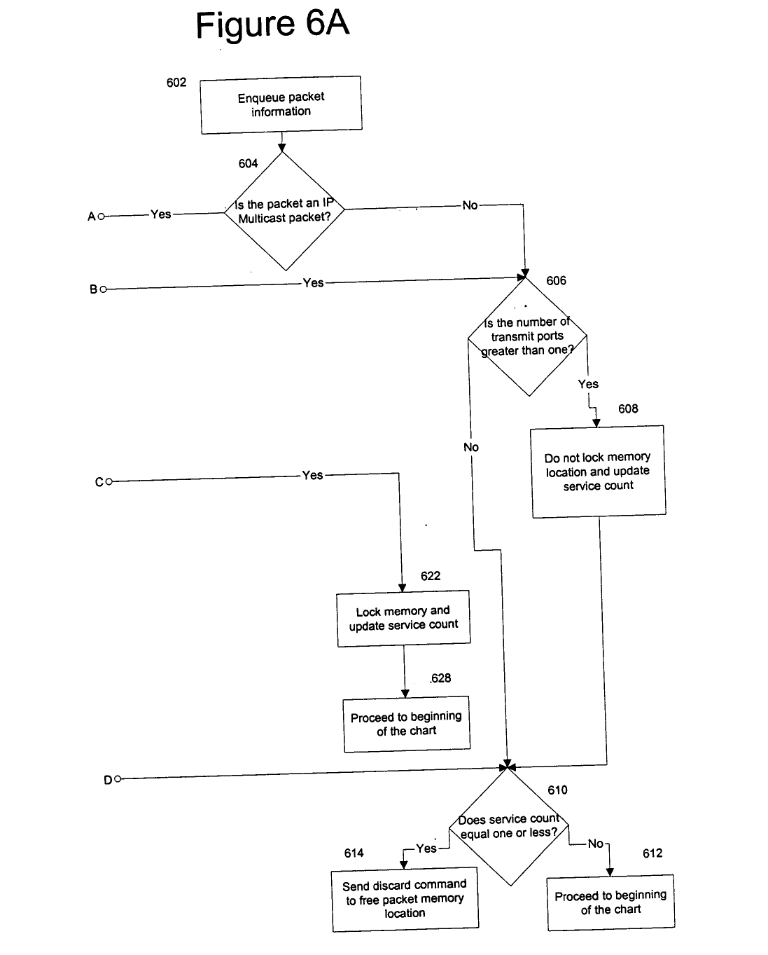

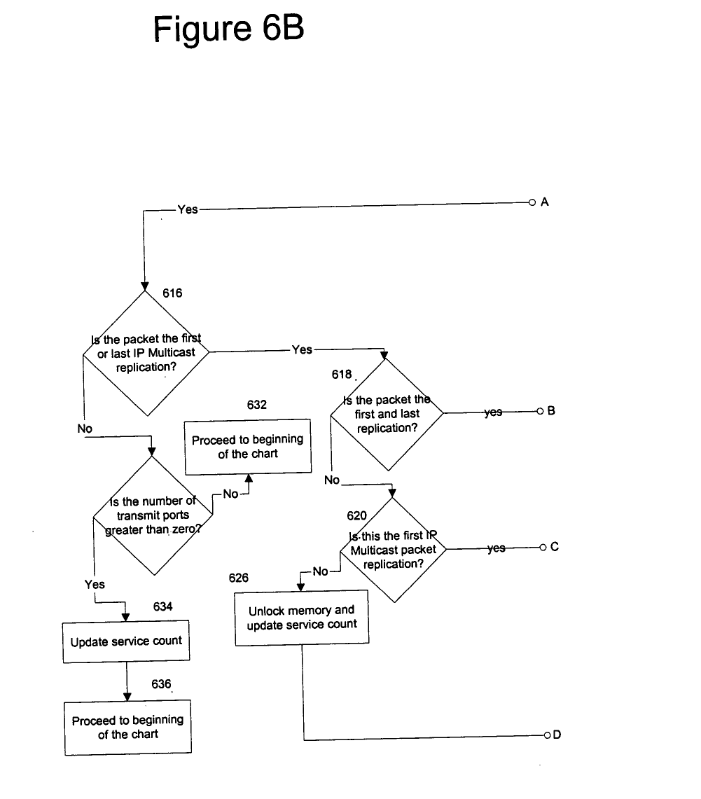

Referring to FIG. 5, a process 500 to handle replication using a locking mechanism is shown. In the process, the packet is received 501 and stored 502 in an identified available memory location. The packet header is put into a memory queue. The packet is replicated 504. From the replicated packet the processor determines the availability of the memory location storing the packet. This is done by updating and determining 506 the status of both the lock mechanism and a service count. From the replication header the processor can determine what type of packet the replication is, e.g. unicast, layer 2 multicast, or an IP multicast. The process also determines from the header if the replication is a first or last replication and the number of ports from which the replications is to be transmitted. Based on this information the process updates the lock and the service count (as discussed later and shown in FIG. 6). The process transmits 508 the replication to a required transmission port. Again the service count and lock status is updated 510. If the replication has not been transmitted to each required ports 512, the process returns to transmit the replicated packet 508. If the replication has been transmitted to each required transmission ports 512 the process determines 514 if further replication of the packet is required. If further replication is required, e.g., the preceding replication was not the last replication, the process 500 proceeds to produce the next replication 504. If the replication is the last replication the processing of the packet is complete 516.

The lock and the service count can be stored in an array in memory. The array has a width equal to the number of IP multicast replications of a packet sent out. This approximates to the maximum number of IP multicast replications, e.g. the number of transmit ports of the server. The depth of the array is equal to the packet memory depth. When a packet is received the array is searched to find a memory location that is unlocked. When an unlocked location is found, the packet is stored in the unlocked packet memory location. The lock and service count initially are in an unlocked state and equal to zero, respectively. As packets are stored to memory locations the lock and service count of the array is updated.

Referring to FIG. 6A details of the process 506 of updating the lock and the service count 600 are shown. In process 506, the packet information is received 602. The process 506 determines 604 the type of replication, e.g. unicast, layer 2 multicast, or IP multicast. If the replication is a layer 2 multicast or a unicast packet the process 506 next determines 606 if the number of transmit ports of the replication is greater than one. If the number of transmit ports is not greater than one, the process 506 does not update the service count. The process checks 610 to see if the service count is equal to one. If the number of transmit ports is greater than one 608, the lock is unlocked and the service count is set equal to the number of transmit ports and/or decremented by the number that have been transmitted. If the number of transmit ports is not equal to one 610, the process starts again at the beginning 612. The process cycles for each transmitted packet until the number of transmit ports is equal to one. At that point the service count equals one and the memory location is made available for storage 614.

For example, a layer 2 multicast packet, initially with two transmit ports, cycles through the chart for the first time and the lock state is set to unlock and the service count is set 608 equal to two. On the second transmitted packet the processor cycles back through the chart. The process determines 604 that the packet is a layer 2 multicast packet and determines 606 that the number of transmit ports is greater than one. The service count is updated 608 to one because the first packet has been transmitted. Since the service count is equal to one 610 the memory location is made available for storage 614.

If however, the packet is a unicast packet the number of transmit ports would be set equal to one based on the definition of a unicast packet. The processor would determine 604 that it is not an IP multicast packet. The processor would then determine 606 that the number of transmit ports is not greater then one. The processor would not lock the memory and the service count would not need to be updated. The memory location would be made available 614 because the memory status is unlocked and the service count is equal to one or less 610.

If the packet is an IP multicast with one replication for one port, the processor determines 604 the packet is an IP multicast and proceeds to the left branch of the flowchart.

Referring to FIG. 6B, the process determines 616 if the replication is a first or last replication. Since it is the first replication in this example, the process would then determine 618 if it is both the first and last replication, e.g. only one replication being transmitted. If it is the first and last replication, the processor would then determine 606 if the number of transmit ports is greater than one. If the number of transmit ports is not greater then one, e.g. one or zero, the process does not update the service count and makes the memory location available for storage 614. If the number of transmit ports is greater than one 606 the lock is unlocked and the service count is set 608 equal to the number of transmit ports. If the number of transmit ports is not equal to one 610, the process transmits the packet, decrements the service count, and starts the update 612 process for the next packet to be transmitted. The process cycles back through the process for each transmitted packet until the number of transmit ports is equal to one 606. At that point the lock is unlocked and the service count equals one 608 so the memory location is made available 614.

If the packet was an IP multicast replication with three replications, the processor determines 604 the packet is an IP multicast packet. The processor determines 616 that it is the first IP multicast replication. The processor determines 618 that the replication is not both the first and last replication. The processor would next determine 620 that the replication is the first replication. Therefore it would change 622 the lock status to locked and set 622 the service count equal to the number of ports for that respective IP multicast replication. The process would begin again 628 at the top of the chart. The service count continues to decrement for each transmission on each intended port for the prior IP multicast replication.

The second IP multicast replication in this example would begin the process. The process determines 604 that the second IP multicast replication is an IP multicast packet. The process determines 616 that the packet is not the first or the last IP multicast replication. The processor determines 630 if the number of transmit ports is greater then zero. If the number of transmit ports is not greater than zero the service count is not incremented and the processing of the third replication would begin 632 at the top of the chart. If the number of transmitting ports is greater than zero the service count is incremented 634 by the number of transmit ports for that respective replication and the processing 636 of the third replication begins. Meanwhile the service is decremented each time a previous packet is transmitted.

The process determines 604 that the third IP multicast replication is an IP multicast packet. The process determines 616 that the packet is either the first or the last IP multicast replication. The process determines 618 that the replication is not the first and last replication. The process determines 620 that the replication is not the first IP multicast replication. The memory is unlocked 626 and the service count is incremented 626 by the number of transmission ports for that respective replication. Even though the memory is unlocked the location is still not made available for storage until the service count is equal to zero. After each transmission the service count is decremented. Once the service count is equal to one 610, e.g. replications have been transmitted, the memory location is made 614 available.

The lock and service count provides an efficient way of preventing packets from being overwritten in memory. A combination of both a lock and count allows the network processor to efficiently use memory space while handling a variety of packets. Some packet types do not require replications to be transmitted out of multiple ports. In this example, the count would be set to the number of replications for the single transmit port. The memory location would not have to be locked because when the count equals zero, the required number of replications is complete.

However, if the packet were an IP multicast packet the first replication may require three transmit ports. If these replications were transmitted prior to determining the number of transmit ports for the second replication, the count could be equal to zero prior to all replications being completed for the packet and the memory location could be erased. The lock mechanism prevents this from happening. The memory location is locked when the process determines that the packet has successive replications. The combination of both the lock and count allows the network processor to handle a variety of packets and prevent erasing memory locations prior to completion of packet processing.

In this embodiment the service count is incremented or decremented by increments of one equal to one transmission port. However, in another embodiment the increment could be other predetermined values. Also in this embodiment the service count is initially set at a value of zero and incremented by the number of transmission ports and decremented by the number of transmitted packets. However, in other embodiments the initial value could be any predetermined value and the value could be incremented or decremented based on various action.

Also in this embodiment a packet memory location becomes available when both the services count equals zero and the lock is in an unlocked state. If, for example, the packet memory location is unlocked but the service count is equal to one, the memory location is still unavailable. Likewise if the memory location is locked and. the service count is equal to zero, the memory location is still unavailable.

A number of embodiments of the invention have been described. Nevertheless, it will be understood that various modifications may be made without departing from the scope of the invention. For example, the service count or lock mechanism could be used independently of each other. In this embodiment, for example, a packet memory location would be made available once the lock was unlocked. In another embodiment, the service count can be used independently without a lock mechanism. In this embodiment a packet memory location would be made available when the service count equaled a predetermined value. Accordingly, other embodiments are within the scope of the following claims.

1. A method for processing data packets comprises:
storing a data packet in a memory location and
locking the memory location when the data packet is an internet protocol multicast packet.

2. The method of claim 1 further comprises:
setting a count based on a number of transmission ports of the data packet.

3. The method of claim 2 further comprises:
decrementing the count after each transmission of the data packet.

4. The method of claim 2 further comprises:
making the memory location unlockable when the status count is equal to a predetermined value.

5. The method of claim 1 wherein the memory location is locked when the data packet is a first replication of an internet protocol multicast packet with multiple replications.

6. The method of claim 1 further comprises:
unlocking the memory location when the data packet is a last replication of an internet protocol multicast packet.

7. A computer program product, disposed on a computer readable medium, for processing data packets comprises instruction for causing a processor to:
store a data packet in a memory location and
lock the data packet memory location when the data packet is an internet protocol multicast packet.

8. The program of claim 7 further comprises instruction for causing a processor to:
set a count based on a number of transmission ports of the data packet.

9. The program of claim 8 further comprises instruction for causing a processor to:
decrement the count after each transmission of the data packet.

10. The program of claim 8 further comprises instructions for causing a processor to:
make the memory location unlockable when the status count is equal to a predetermined value.

11. The program of claim 7 wherein instructions to locking the memory location occur when the data packet is a first replication of an internet protocol multicast packet with multiple replications.

12. The program of claim 7 further comprises instructions for causing a processor to:
unlock the memory location when the data packet is a last replication of an internet protocol multicast packet.

13. A system for processing a data packet, the system comprises:
at least one communication port;
at least one Ethernet MAC (Medium Access Control) device coupled to at least one of the at least one communication ports;
at least one processor having access to the at least one Ethernet MAC device; and instructions for causing at least one processor to:
store a data packet in a memory location and
lock the data packet memory location when the data packet is an internet protocol multicast packet.

14. The system of claim 13 further comprises instruction for causing at least one processor to:
set a count based on a number of transmission ports of the data packet.

15. The system of claim 14 further comprises instruction for causing at least one processor to:
decrement the count after each transmission of the data packet.

16. The system of claim 14 further comprises instruction for causing at least one processor to:
make the memory location unlockable when the status count is equal to a predetermined value.

17. The system of claim 13 wherein instructions for causing at least one processor to locking the memory location occur when the data packet is a first replication of an internet protocol multicast packet with multiple replications.

18. The system of claim 13 further comprises instructions for causing at least one processor to:
unlock the memory location when the data packet is a last replication of an internet protocol multicast packet.

19. A device for processing data packets comprises:
a module to store a data packet in a memory location and
a module to lock the data packet memory location when the data packet is an internet protocol multicast packet.

20. The device of claim 19 further comprises:
a module to set a count based on a number of transmission ports of the data packet.

21. The device of claim 20 further comprises:
a module to decrement the count after each transmission of the data packet.

22. The device of claim 20 further comprises:
a module to make the memory location unlockable when the status count is equal to a predetermined value.

23. The device of claim 20 wherein the module to lock the memory location occurs when the data packet is a first replication of an internet protocol multicast packet with multiple replications.

24. The device of claim 20 further comprises:
a module to unlock the memory location when the data packet is a last replication of an internet protocol multicast packet.
